(19) United States
(12) Patent Application Publication
(10) Pub. No.: US 2025/0312715 A1
(43) Pub. Date: Oct. 9, 2025

(54) FILTER MODULE ADAPTED TO MULTIPLE TYPES OF WATER OUTLET COMPONENTS

(71) Applicant: Xiamen EASO Co., Ltd., Xiamen (CN)

(72) Inventors: Yang-Yu CHANG, Xiamen (CN); Yujie XU, Xiamen (CN); Zhen LI, Xiamen (CN); Miaoling SHEN, Xiamen (CN)

(21) Appl. No.: 18/818,674

(22) Filed: Aug. 29, 2024

(30) Foreign Application Priority Data
Apr. 8, 2024 (CN) 202410412882.6

(51) Int. Cl. B01D 35/30; B05B 15/40

(52) U.S. Cl. CPC B01D 35/306; B05B 15/40; B01D 2201/4053; B01D 2201/4061; B01D 2201/4084

(57) ABSTRACT

A filter module adapted to multiple types of water outlets, includes a main body connected to the water inlet pipe at one end, a detachable water outlet joint, a cavity for installing a filter element between the inner cavity of the main body and the inner cavity of the water outlet joint; atleast one penetration hole is provided on the side wall of the water outlet joint, a button is provided in the penetration hole, the button is capable of moving along the penetration hole relative to the water outlet joint, a connecting piece inserted into the water outlet joint at the end toward the water outlet joint, a snap-in-groove is provided on the inner peripheral wall of the connecting piece, a snap-in-block inserted into the snap-in-groove is provided on the button, so that the filter element can be replaced quickly, and for replacing different water outlet modules simultaneously.

### TECHNICAL FIELD

The present invention relates to a filter module adapted to multiple types of water outlet components.

### BACKGROUND

The existing showerhead is a pre-filtration, and because the showerhead is set in a relatively high position, which is higher than the height of a normal person, resulting in its disassembly is extremely inconvenient, need to use ladders, chairs and other tools in order to replace the filter element used for filtration, and the single filtration structure cannot meet the usage habits of different members of the family; and the existing structure is very complex, with high production costs.

### SUMMARY OF THE INVENTION

In order to solve the above technical problems, the purpose of the present invention is to provide a filter module adapted to multiple types of water outlet components.

The present invention is implemented through the following technical solutions:

A filter module adapted to multiple types of water outlet components, includes a main body which can be connected to the water inlet pipe at one end, where a detachable water outlet joint being provided at the other end of the main body, a cavity for installing a filter element being formed between the inner cavity of the main body and the inner cavity of the water outlet joint; at least one penetration hole is provided on the side wall of the water outlet joint, a button is provided in the penetration hole, the button is capable of moving along the penetration hole relative to the water outlet joint, a connecting piece which can be inserted into the water outlet joint is provided at one end toward the water outlet joint of the main body, a snap-in groove is provided on the inner peripheral wall of the connecting piece, a snap-in block which can be inserted into the snap-in groove is provided on the button.

In the embodiments of the present invention, a spring that extends and retracts along the radial direction of the water outlet joint is provided between the button and the water outlet joint, the spring is capable of driving the button moves toward the outer periphery of the water outlet joint, a protrusion is provided in a part of the button located inside the water outlet joint, and a limiting block is provided inside the water outlet joint, the protrusion is capable of cooperatively connecting with the limiting block in such a way as to enable the button to be restricted to the water outlet joint.

In the embodiments of the present invention, a sinking groove which along the radial direction of the water outlet joint is provided in the inside of the water outlet joint, and the button is provided with a pin shaft that extends into the sinking groove, the outer periphery of the pin shaft is fitted with a spring, and one end of the spring can be placed in the sinking groove.

In the embodiments of the present invention, a first guiding bevel is provided in the inner periphery of one end of the connecting piece facing the water outlet joint, and a second guiding bevel is provided in the outer periphery of the end of the snap-in block, and the connecting piece is capable of driving the button to move towards the water outlet joint when the first guiding bevel is matched with the second guiding bevel.

In the embodiments of the present invention, the button is also provided with a slot, and the connecting piece can be inserted into the slot, the slot is located between the pressing part of the button and the snap-in block, and the snap-in block is provided on the side of the button towards an outlet end of the main body, the button is provided with an elastic piece, and the protrusion is provided on the elastic piece.

In the embodiments of the present invention, the water outlet joint further includes a sleeve, the sleeve being provided on the inner side of the water outlet joint, and the sleeve extending into the interior of the main body, one end of the filter element being able to be fixed inside the sleeve, and the other end of the filter element being able to be matched and connected with the main body.

In the embodiments of the present invention, a guiding bevel is provided on the inner peripheral wall of the sleeve, the sleeve is provided with a clamping groove on the side wall which is compatible with the guiding bevel, the filter element is provided with a buckle on the outer periphery, and the buckle is able to be moved along the guiding bevel and then cooperatively connected with the clamping groove, so as to connect the filter element and the water outlet joint together.

In the embodiments of the present invention, a pressure spring telescoping along the axial direction of the main body is provided in the inside of the cavity, one end of the pressure spring being cooperatively connected to the main body, and the other end of the pressure spring being cooperatively connected to the filter element or the water outlet joint.

In the embodiments of the present invention, it further comprises a ball head and a upper cover, the ball head being able to be cooperatively connected to the inlet end of the body, the upper cover being able to be cooperatively connected to the outer periphery of the body to connect the ball head to the body; the outlet end of the ball head being able to be cooperatively connected to an outlet end of the filter element.

In the embodiments of the present invention, the water outlet joint further comprises a water outlet connector, the water outlet connector being capable of being connected to the outlet end of the filter element, the water outlet connector being provided in the axial or radial direction of the water outlet joint.

The present invention of a filter module adapted to multiple types of water outlet components has the following beneficial effects: the overall structure is simple, the operation is easy and convenient, and the water outlet joint can be quickly installed and disassembled from the main body, so that it is convenient to replace the filter element; and at the same time, the water outlet joint can be designed in various ways, which can be suitable for products with multiple designs of showerheads.

This structural of the product can be replaced with different types of modules, such as several different water outlet modules shown in, which resulting in lower production and development costs for different water outlet modules.

### BRIEF DESCRIPTION OF THE DRAWINGS

In order to more clearly illustrate the technical solution of the present invention, the following will briefly introduce the accompanying drawings that need to be used in the description of the embodiments or prior art, and it will be obvious that the accompanying drawings in the following description are only some embodiments of the present invention, and other accompanying drawings can be obtained according to these drawings for the person of ordinary skill in the field without putting in creative labor.

FIG. 1 is a schematic diagram of the present invention.

FIG. 2 is a sectional view I of the present invention.

FIG. 3 is an enlarged schematic view at A in FIG. 2.

FIG. 4 is a sectional view II of the present invention.

FIG. 5 is an exploded view of the present invention.

FIG. 6 is a schematic view of a water outlet joint in the present invention.

FIG. 7 is a schematic diagram of embodiment one in the present invention.

FIG. 8 is a schematic diagram of embodiment two in the present invention.

FIG. 9 is a schematic diagram of embodiment three in the present invention.

FIG. 10 is a schematic diagram of embodiment four in the present invention.

FIG. 11 is a schematic diagram of the button in the present invention.

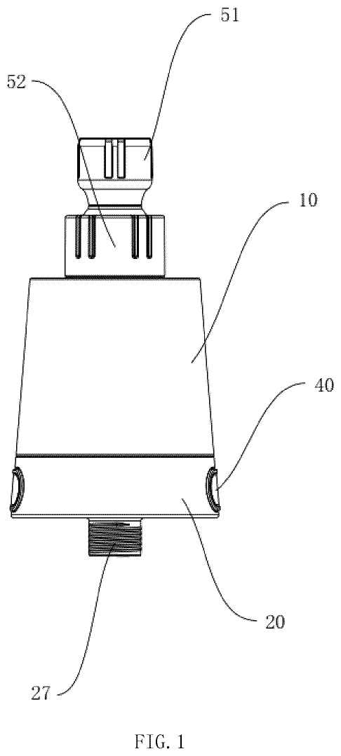

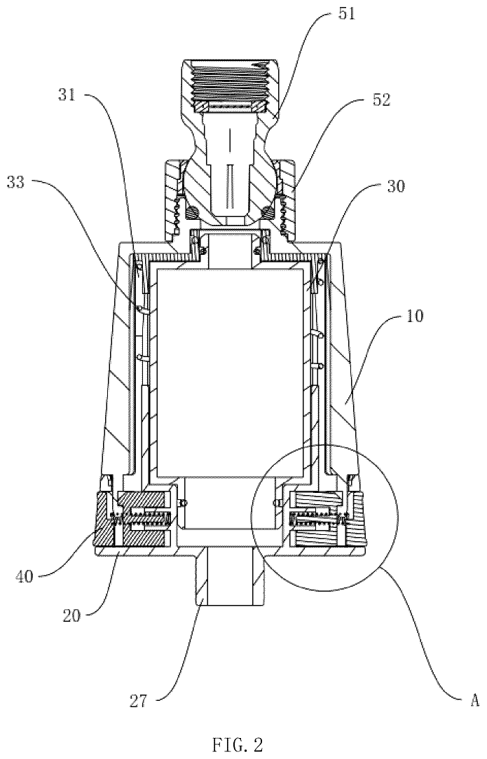

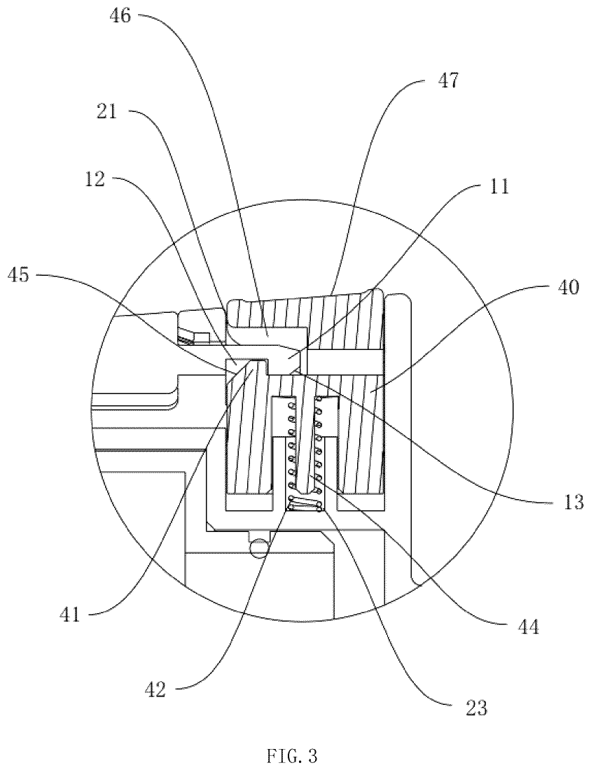

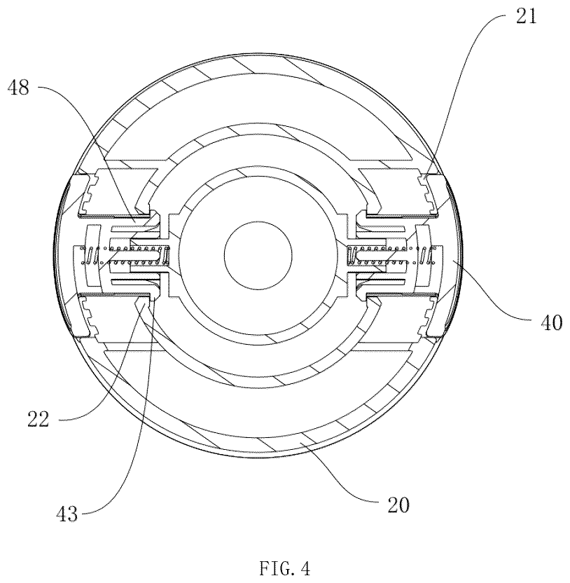

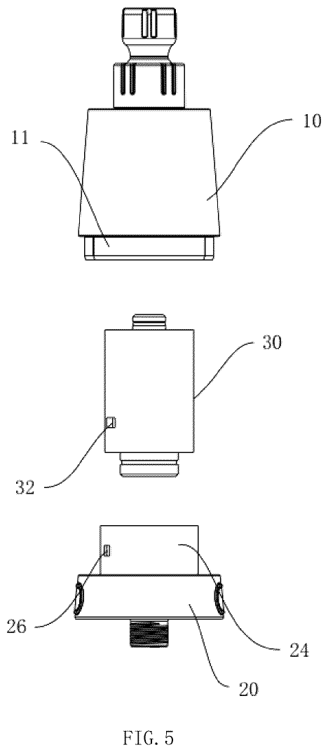

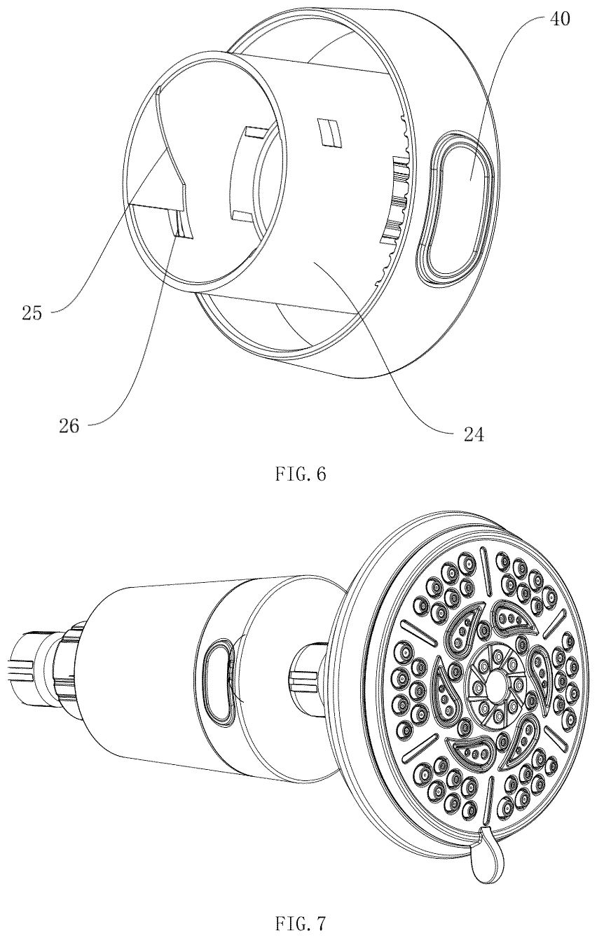

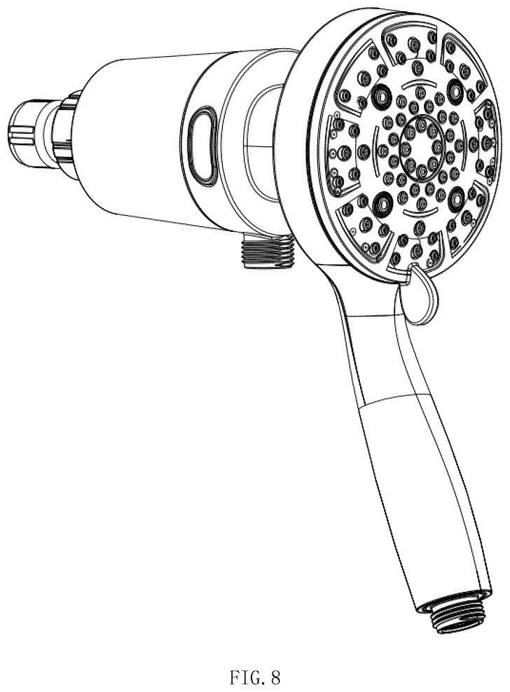

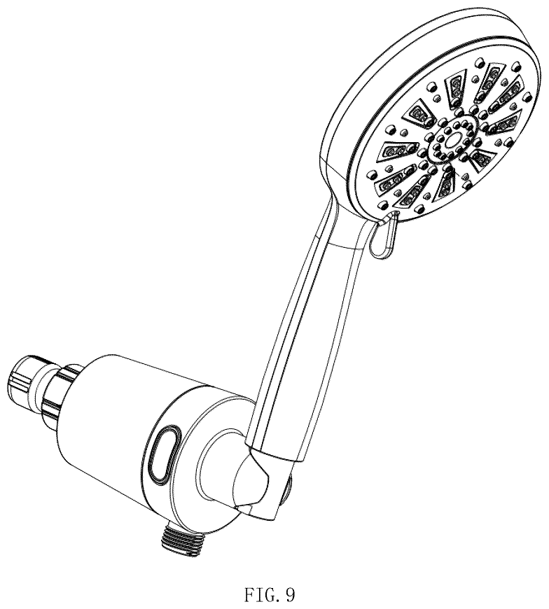

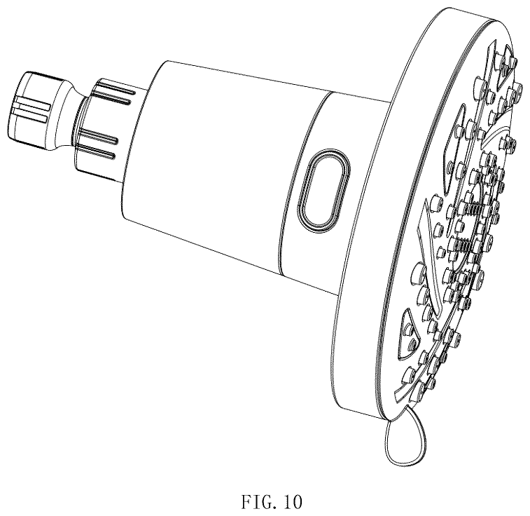

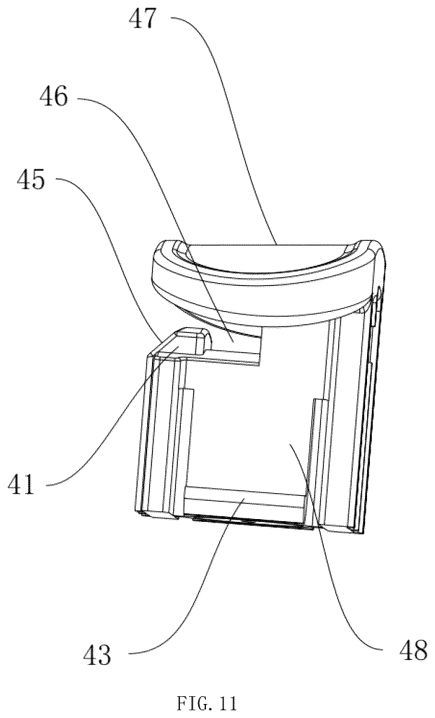

### DETAILED DESCRIPTION OF THE EMBODIMENTS

In order to make the objects, technical solutions and advantages of the embodiments of the present invention clearer, the technical solutions in the embodiments of the present invention will be described clearly and completely in the following in conjunction with the accompanying drawings in the embodiments of the present invention, and it is clear that the described embodiments are a part of the embodiments of the present invention and not all of the embodiments. Based on the embodiments in the present invention, all other embodiments obtained by a person of ordinary skill in the art without creative labor fall within the scope of protection of the present invention. Accordingly, the following detailed description of the embodiments of the present invention provided in the accompanying drawings is not intended to limit the scope of the present invention for which protection is claimed, but rather represents only selected embodiments of the present invention. Based on the embodiments in the present invention, all other embodiments obtained by a person of ordinary skill in the art without creative labor fall within the scope of protection of the present invention.

In the description of the present invention, it is to be understood that the terms “center”, “longitudinal”, “lateral”, “length”, “width”, “thickness”, “top”, “bottom”, “front”, “back”, “left”, “right”, “vertical”, “horizontal”, “top”, “bottom”, “inside”, “outside,” “clockwise,” “counterclockwise,” and the like indicate orientation or positional relationships based on those shown in the accompanying drawings, solely for the purpose of facilitating description of the present invention and simplifying the description They are not intended to indicate or imply that the devices or elements referred to must have a particular orientation, be constructed and operated in a particular orientation, and therefore are not to be construed as a limitation of the present invention.

Furthermore, the terms “first” and “second” are used for descriptive purposes only and are not to be understood as indicating or implying relative importance or implicitly specifying the number of technical features indicated. Thus, a feature defined with the terms “first”, “second” may expressly or implicitly include one or more such features. In the description of the present invention, “more than one” means two or more, unless otherwise expressly and specifically limited.

In the present invention, unless otherwise expressly provided and limited, the terms “mounted”, “connected”, “fixed”, etc. are to be understood in a broad sense, for example, it can be a fixed connection, a removable connection, or a one-piece connection; it can be a mechanical connection or an electrical connection; it can be a direct connection or an indirect connection through an intermediary medium, and it can be a connectivity within the two elements or an interaction between the two elements. For those of ordinary skill in the art, the specific meanings of the above terms in the present invention may be understood on a case-by-case basis.

In the present invention, unless otherwise expressly provided and limited, “over” or “under” the first feature of the second feature may include direct contact of the first and second features, or may include contact of the first and second features not directly but by means of an additional feature between them. Furthermore, the first feature being “above” the second feature includes the first feature being directly above and diagonally above the second feature, or simply indicating that the first feature is horizontally higher than the second feature. The first feature being “below”, “under”, and “beneath” the second feature includes the first feature being directly below and diagonally below the second feature, or simply indicating that the first feature is horizontally smaller than the second feature.

With reference to the accompanying drawings of the specification, a filter module adapted to multiple types of water outlet components, includes a main body 10 which can be connected to the water inlet pipe (not shown in the drawings) at one end (i.e., the water inlet end), the water inlet pipe preferably can be 7-shaped bend so that a showerhead can be provided in the vicinity of the main body. A detachable water outlet joint being provided at the other end (i.e. the water outlet end) of the main body, the water outlet joint 20 and the main body 10 can be disassembled relative to each other, so as to facilitate the replacement of the filter element, and a cavity 31 for installing a filter element 30 being formed between the inner cavity of the main body 10 and the inner cavity of the water outlet joint 20; the water outlet joint 20 is in the shape of a ring, at least one penetration hole 21 running in the radial direction along the water outlet joint 20 is provided on the side wall of the water outlet joint, which in one use is provided with two penetration holes 21 running through the inner peripheral side of the water outlet joint, and the two penetration holes 21 are relatively symmetrically provided on the water outlet joint 20; a button 40 is provided in the penetration hole 21, the button 40 passing through the penetration hole 21, and the button 40 is capable of moving along the penetration hole relative to the water outlet joint 20, specifically: the button 40 being able to be pressed to be moved towards the inside of the water outlet joint 20, which can be said to be moved in a radial direction along the water outlet joint 20; a connecting piece which can be inserted into the water outlet joint is provided at the end toward the water outlet joint of the main body, the connecting piece 11 may be an annular piece, and the connecting piece 11 is provided with a snap-in groove 12 on the inner peripheral wall of the end where the connecting piece 11 is inserted into the interior of the water outlet joint 20, and the snap-in groove 12 may also be an annular groove, and a snap-in block 41 which can be inserted into the snap-in groove 12 is provided on the button 40; through the cooperation between the snap-in groove 12 and the snap-in block 41, the connection between the button 40 and the main body 10 can be realized, and ultimately the connection between the water outlet joint and the main body can be realized.

Preferably, a spring 42 that extends and retracts along the radial direction of the water outlet joint 20 is provided between the button 40 and the water outlet joint 20, the spring 42 is capable of driving the button 40 moves toward the outer periphery of the water outlet joint 20, which ensures that the water outlet joint 20 and the main body 10 can be stably connected together. A protrusion 43 is provided in a part of the button 40 located inside the water outlet joint 20, and a limiting block 22 is provided in inside of the water outlet joint 20, the protrusion 43 is capable of cooperatively connecting with the limiting block 22, and the protrusion 43 is hooked to the limiting block 22, which in such a way as to enable the button to be restricted to the water outlet joint 20, and the button 40 will not be bounced away from the penetration holes 21 by the action of the spring 42.

Further, a sinking groove 23 which along the radial direction of the water outlet joint 20 is provided in the inside of the water outlet joint 20, and the button 40 is provided with a pin shaft 44 that capable of mating with the sinking groove 23, specifically, the pin shaft 44 extends into the sinking groove 23; the outer periphery of the pin shaft 40 is fitted with a spring 42, and one end of the spring 42 can be placed at the bottom of the sinking groove 23, and the other end of the spring 42 being in contact with the button 40, so as to ensure that the spring 42 maintains its axial stability and will not be twisted in use.

And furthermore, a first guiding bevel 13 is provided in the inner periphery of the end of the connecting piece 11 facing the water outlet joint 20, and a second guiding bevel 45 is provided in the outer periphery of the end of the snap-in block 41, the first guiding bevel 13 is parallel to the second guiding bevel 15, and when the button 40 is inserted into the penetration hole 21, the first guiding bevel 13 is in contact and cooperation with the second guiding bevel 45, and the connecting piece 11 is capable of driving the button to move towards the water outlet joint 20, and in moving the connecting piece 11 relative to the water outlet joint 20, the snap-in block 41 can be pressed inwardly and then moved outwardly under the action of the spring 42, so that the snap-in block 41 can be snapped into the snap-in groove 12, completing the connection between the snap-in groove 12 and the snap-in block 41.

In a preferred embodiment, the button 40 is also provided with a ring shaped slot 46 on the end of the button 40 towards the water outlet end of the main body 10, and the connecting piece 11 can be inserted into the slot 46, the slot 46 is located between the pressing part 47 of the button 40 and the snap-in block 41; the snap-in block 41 is provided on the side of the button 40 towards the water outlet end of the main body 10, the button 40 is provided with an elastic piece 48, which facilitates to install the button 40 to be mounted on the water outlet joint 20, and the protrusion 43 is provided on the elastic piece 48, the elastic piece 48 can be provided in two pieces which located on the side of the snap-in block 41, and the elastic piece 48 is located away from the water inlet end of the main body 10 relative to the snap-in block 41, while the slot 46 can be located between the two elastic piece 48 and the snap-in block 41.

Preferably, the water outlet joint 20 further includes a sleeve 24, the sleeve 24 is coaxially fixedly provided on the inner side of the water outlet joint 20, and the sleeve 24 extends into the interior of the main body 10, a sinking groove 23 is provided on the outer peripheral side wall of the sleeve 24, and the penetration holes 21 are not connected with the inner cavity of the sleeve 24; one end of the filter element 30 extends into and is fixed in the sleeve 24, and the other end of the filter element 30 extends into and is matingly connected with the main body 10. A guiding bevel 25 is provided on the inner peripheral wall of the sleeve 24, the sleeve 24 is provided with a clamping groove 26 on the side wall which is compatible with the guiding bevel 25, the filter element 30 is provided with a buckle 32 on the outer periphery, and the buckle 32 is able to be moved along the guiding bevel 25 and then cooperatively connected with the clamping groove 26, so as to connect the filter element 30 and the water outlet joint 20 together, and when the present invention is in use, the filter element 30 is first connected to the water outlet joint 20, and then matingly connected to the main body 10.

Further, a pressure spring 33 telescoping along the axial direction of the main body 10 is provided in the inside of the cavity 31, one end of the pressure spring 33 being cooperatively connected to the main body 10, and the other end of the pressure spring 33 being cooperatively connected to the filter element 30 or the water outlet joint 20, which when the pressure spring 33 can disengage the snap-in block 41 from the snap-in groove 12, the water outlet joint 20, the filter element 30 can be separated from the main body 10.

And furthermore, it further comprises a ball head 51 and a upper cover 52, the ball head 51 being able to be cooperatively connected to the water inlet end of the main body 10, the water outlet end of the ball head 51 is connected to the water inlet end of the main body 10, the upper cover 52 being able to be cooperatively connected with the outer periphery of the main body 10 to connect the ball head 51 with the main body 10; the water outlet end of the ball head 51 being able to be cooperatively connected to the water outlet end of the filter element 30. In specific use, the seals are provided between parts having water over them for preventing water leakage.

The present invention in one use, the water outlet joint 20 further includes a water outlet connector 27, the water outlet connector 27 being capable of being connected to the water outlet end of the filter element 30, the water outlet connector 27 being provided in the axial or radial direction of the water outlet joint 20; when the water outlet connector 27 is set in the same axial direction as the water outlet joint 20, it can be directly connected to the rosette head, and when the water outlet connector 27 is located in the radial direction of the water outlet joint 20, it can be set in the axial direction of the water outlet joint 20 with the socket of the shower or the connecting portion (magnetically connecting) through the hose to realize the water passage of the water outlet connector and the showerhead, and the specific can be referenced in the way of the design of the water outlet joint.

The present invention can be replaced by simply pressing the button, this action not only can be carried out to replace the filter element, but also to replace the water outlet joint, which so that the present invention can be adapted to a variety of products, and can be adapted to the structure of the present invention through the production and development of new types of water outlet joint, and has cost advantages due to its simplicity of the operation and the structure.

More specifically: the whole structure can be divided into three modules: 1. the main body as a module; 2. the filter element as a module; 3. the water outlet joint as a module. Among them, the water outlet joint can be replaced. Currently there are 4 design ways: 1. the water outlet joint is compatible with the ordinary rosette head, and both of them can be screwed through the conventional thread; 2. the water outlet joint and the showerhead fit together by means of magnetic suction through the magnetic suction structure; 3. the water outlet joint is matched with the ordinary shower through the socket, and the regular showerhead can be directly hung up; 4. the water outlet joint can be used directly as a rosette head, which making the water outlet joint more diversified design; the water outlet joint 20 mated with the filter element 30: the filter element 30 is equipped with a protruding buckle 32 on the outer periphery, the water outlet joint 20 is equipped with a clamping groove 26, firstly, the bump of the filter cartridge 30 is inserted into the water outlet joint 20 by rotating and applying pressure to lock, which forming a water filtration assembly, this way can be operated in the reverse direction for splitting the water outlet joint 20 and the filter element 30; the water filtration assembly is pressed directly into the main body 10, and is guided to be inserted into the main body 10 directly through the button 40, and due to the action of the spring 42, the button 40 is pushed into the snap-in groove 12, at which time the structure is locked and can be used with water supply. When removing and replacing the filter element or water outlet joint: pressing the upper and lower buttons 40, the snap-in block 41 of the button 40 separates from the snap-in groove 12 inside of the main body 10, and the elastic force of the pressure spring 33 inside of the cavity 31 ejects the whole assembly for filtering out water. The main body 10: through the ball head 51 and the upper cover 52 with the locking into the main body 10, this function allows the whole filter rosette head has a ball head can be adjusted in angle. The water outlet joint 20 cooperates with the button 40 by having upper and lower limits, and there is a plurality of springs 42 between the two, and the springs 42 act as a reset when pressed or without operated.

The foregoing description illustrates and describes the preferred embodiments of the present invention, and as previously mentioned, it should be understood that the present invention is not limited to the form disclosed herein, and should not be regarded as exclusive of other embodiments, but may be utilized in a variety of other combinations, modifications, and environments and is capable of being altered by the above teachings or by skill or knowledge in the relevant field, within the scope of the utility model concept described herein. And the alterations and changes made by those in the art that do not depart from the spirit and scope of the present invention shall all be within the scope of protection of the appended claims of the present invention.

1. A filter module adapted to multiple types of water outlet components, comprising a main body which can be connected to the water inlet pipe at one end, wherein a detachable water outlet joint being provided at one other end of the main body, a cavity for installing a filter element being formed between the inner cavity of the main body and the inner cavity of the water outlet joint; at least one penetration hole is provided on a side wall of the water outlet joint, a button is provided in the penetration hole, the button is capable of moving along the penetration hole relative to the water outlet joint, a connecting piece which can be inserted into the water outlet joint is provided at one end toward the water outlet joint of the main body, a snap-in groove is provided on an inner peripheral wall of the connecting piece, a snap-in block which can be inserted into the snap-in groove is provided on the button.

2. A filter module adapted to multiple types of water outlet components as claimed in claim 1, wherein a spring that extends and retracts along the radial direction of the water outlet joint is provided between the button and the water outlet joint, the spring is capable of driving the button moves toward an outer periphery of the water outlet joint, a protrusion is provided in a part of the button located inside the water outlet joint, and a limiting block is provided inside the water outlet joint, the protrusion is capable of cooperatively connecting with the limiting block in such a way as to enable the button to be restricted to the water outlet joint.

3. A filter module adapted to multiple types of water outlet components as claimed in claim 2, wherein a sinking groove which along the radial direction of the water outlet joint is provided in the inside of the water outlet joint, and the button is provided with a pin shaft that extends into the sinking groove, an outer periphery of the pin shaft is fitted with a spring, and one end of the spring can be placed in the sinking groove.

4. A filter module adapted to multiple types of water outlet components as claimed in claim 1, wherein a first guiding bevel is provided in an inner periphery of one end of the connecting piece facing the water outlet joint, and a second guiding bevel is provided in an outer periphery of one end of the snap-in block, and the connecting piece is capable of driving the button to move towards the water outlet joint when the first guiding bevel is matched with the second guiding bevel.

5. A filter module adapted to multiple types of water outlet components as claimed in claim 4, wherein the button is also provided with a slot, and the connecting piece can be inserted into the slot, the slot is located between a pressing part of the button and the snap-in block, and the snap-in block is provided on a side of the button towards an outlet end of the main body, the button is provided with an elastic piece, and the protrusion is provided on the elastic piece.

6. A filter module adapted to multiple types of water outlet components as claimed in claim 1, wherein the water outlet joint further comprises a sleeve, the sleeve being provided on an inner side of the water outlet joint, and the sleeve extending into an interior of the main body, one end of the filter element being able to be fixed inside the sleeve, and one other end of the filter element being able to be matched and connected with the main body.

7. A filter module adapted to multiple types of water outlet components as claimed in claim 6, wherein a guiding bevel is provided on an inner peripheral wall of the sleeve, the sleeve is provided with a clamping groove on a side wall which is compatible with the guiding bevel, the filter element is provided with a buckle on an outer periphery, and the buckle is able to be moved along the guiding bevel and then cooperatively connected with the clamping groove, so as to connect the filter element and the water outlet joint together.

8. A filter module adapted to multiple types of water outlet components as claimed in claim 7, wherein a pressure spring telescoping along the axial direction of the main body is provided in the inside of the cavity, one end of the pressure spring being cooperatively connected to the main body, and one other end of the pressure spring being cooperatively connected to the filter element or the water outlet joint.

9. A filter module adapted to multiple types of water outlet components as claimed in claim 7, wherein it further comprises a ball head and a upper cover, the ball head being able to be cooperatively connected to an inlet end of the body, the upper cover being able to be cooperatively connected to the outer periphery of the body to connect the ball head to the body; an outlet end of the ball head being able to be cooperatively connected to an outlet end of the filter element.

10. A filter module adapted to multiple types of water outlet components as claimed in claim 1, wherein the water outlet joint further comprises a water outlet connector, the water outlet connector being capable of being connected to the outlet end of the filter element, the water outlet connector being provided in the axial or radial direction of the water outlet joint.
